(19) United States
(12) Patent Application Publication
(10) Pub. No.: US 2018/0190158 A1
(43) Pub. Date: Jul. 5, 2018

(54) Label

(71) Applicant: Frederick C. Glasier, JR., Huntley, IL (US)

(72) Inventor: Frederick C. Glasier, JR., Huntley, IL (US)

(21) Appl. No.: 15/858,034

(22) Filed: Dec. 29, 2017

Related U.S. Application Data
(60) Provisional application No. 62/440,611, filed on Dec. 30, 2016.

(51) Int. Cl. G09F 3/00

(52) U.S. Cl. CPC G09F 3/0289; G09F 2003/0272; A61J 2205/30

(57) ABSTRACT

A label having a base label member, a fold label member that is in overlying relationship to the base label member. The base label member has a first base label face and a second base label face opposed to the first face. When the fold label member is in the folded state, the folded label member has a first outwardly oriented fold label member face and a second outwardly oriented fold label member face opposed to the first outwardly oriented fold label member face. The label also includes a lamination layer in overlying relationship with the base label member and the fold label member. The lamination layer has a first lamination layer face and a second lamination layer face opposed to the first lamination layer face. The label has a glue hinge that is interposed between the base label member and the lamination layer. In certain embodiments, the glue hinge is positioned in overlaying relationship to a region that is defined on the first base label face and in contact with the fold label member and the lamination layer.

### CROSS-REFERENCE TO RELATED APPLICATION(S)

This application claims priority to and the benefit of U.S. Provisional Application Patent Ser. No. 62/440,611, filed Dec. 30, 2016, the entire disclosure of which is hereby incorporated by reference.

### TECHNICAL FIELD

This disclosure relates to pharmacy and medicinal labels.

### BACKGROUND

Labels units can be used to convey brand identity as well as relevant information such as portion or dose size, recommended use frequency, expiration date, contraindications and the like. In certain products, including but not limited to prescription and non-prescription, an extensive amount of information must be made available to the end consumer. The vast amount of information cannot be easily placed on a conventional two-dimensional label. In certain situations this information is presented on package inserts that are placed lose in boxes or other packaging associated with the container or other delivery device such as an inhaler injection unit or the like. This information can easily become separated from the container or delivery device and be unavailable to the end user when needed.

Materials such as prescription and over-the-counter pharmaceuticals are typically produced by pharmaceutical manufacturers and packagers distributed through a multilayer distribution chain before reaching the end use consumer. In many situations, the pharmaceutical manufacturer and/or packager is charged with the responsibility to see that the appropriate information regarding the compound to be administered reaches the end use consumer. In certain situations, it has been found that package inserts present in an associated box or outer package is not fully effective to this end.

Label configurations have been proposed that can integrate some or all of the desired dosing instruction, contraindications, potential side effects, efficacy, etc., much of which can be required by relevant state and federal regulatory agencies, to the end-use consumer. In many situations, the associated label can be affixed to the container or other dispenser in an essentially permanent manner and can include a folded insert that includes the required information in a pocket defined therein. In certain instances, depending on the associated material being conveyed, the insert can be a multi-folded unit that having multiple faces that bear written indicia associated with information important to the user. In the situations associated with pharmaceutical compositions, the label and associated insert will be sized to fit the associated container. It is desirable that this insert be positioned in the associated label in a manner to permit the user to access and/or remove the insert when desired or required. It is important that the associated label be tamper-resistant and that any attempted tampering be readily apparent. Thus it is desirable to provide a label that can provide indication of tampering and can maintain a folded label member in secure relationship thereto.

### SUMMARY

Disclosed herein are implementations of a label having a base label member, a fold label member that is in overlying relationship to the base label member. The base label member has a first base label face and a second base label face opposed to the first face. When the fold label member is in the folded state, the folded label member has a first outwardly oriented fold label member face and a second outwardly oriented fold label member face opposed to the first outwardly oriented fold label member face. The label also includes a lamination layer in overlying relationship with the base label member and the fold label member. The lamination layer has a first lamination layer face and a second lamination layer face opposed to the first lamination layer face. The label has a glue hinge that is interposed between the base label member and the lamination layer. In certain embodiments, the glue hinge is positioned in overlaying relationship to a region that is defined on the first base label face and in contact with the fold label member and the lamination layer.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is an exploded perspective view of an embodiment of the label as disclosed herein;

FIG. 2 is a perspective view of an embodiment of elements of the label depicted in FIG. 1;

FIG. 3 is a top plan view of an embodiment of elements of the label depicted in FIG. 1;

FIG. 4 is a perspective view of an embodiment of the label and delivery unit as disclosed herein in position on a substrate;

FIG. 5 is a partial cross-sectional view of the label of FIG. 4 taken along its longitudinal length along the 5-5 line of FIG. 4;

FIG. 6 is a partial cross-sectional view of the label of FIG. 4 taken along its latitudinal length along the 6-6 line of FIG. 4; and

FIG. 7 is a partial cross-sectional view of the label of FIG. 4 taken along its latitudinal length along the 7-7 line of FIG. 4.

### DETAILED DESCRIPTION

Disclosed is a label that can be employed to identify products such as medicinal products such as prescription pharmaceuticals, over-the-counter pharmaceuticals as well as other products and/or compounds that require dosing or use instructions. The label as broadly described includes a base label member, a fold label member, and a lamination layer that overlies the base label member and the fold label member. A glue hinge is interposed between the base label member and the fold label member in a manner that contacts both the base label member and the fold label member and is also in contact with the lamination layer. In certain embodiments, the label can also include a support substrate such as a liner layer or the like.

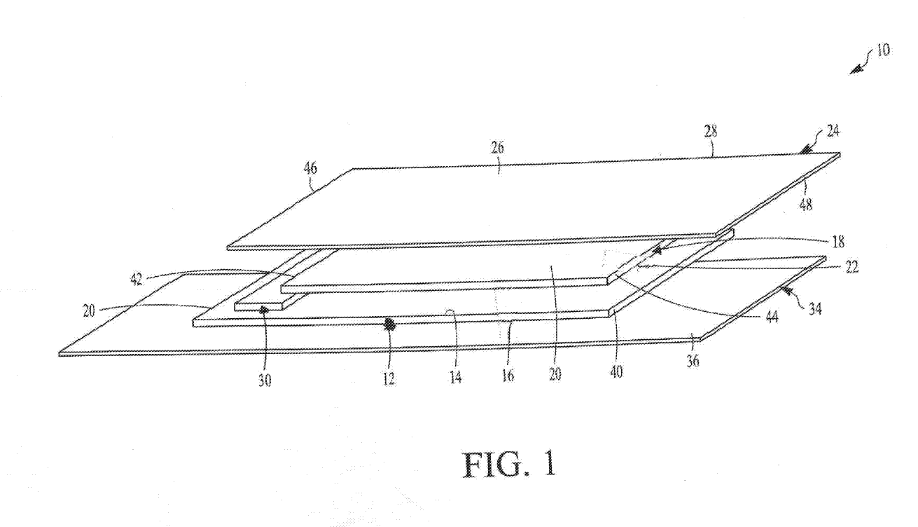

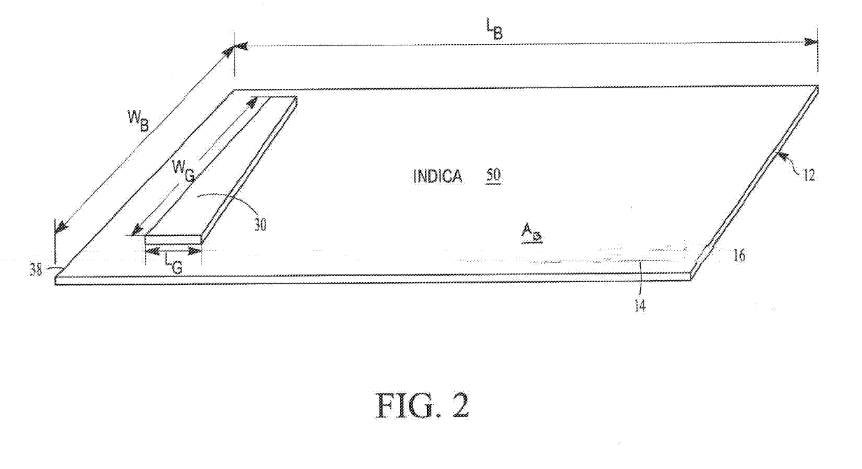

An embodiment of the label 10 is depicted in the various drawing figures. Turning first to FIG. 1, the label 10 includes a base label member 12. The base label member 12 can be an elongate planar member that includes a first base label face 14 and a second base label face 16 that is opposed to the first base label face 14. The base label member 12 can be composed of a material such as a polymer, coated polymer, foil, coated foil or the like that has sufficient thickness and strength to provide structural support for the various elements of label 10. The base label member 12 can be configured to releasable attached to a suitable delivery substrate. The base label member 12 can be configured to be attached to a suitable device such as a container or the like. Non-limiting examples of suitable containers include reclosable vials configured to hold various pills and the like. The label 10 can be affixed to the outer body of the associated container at any suitable region defined thereon. The suitable region can be a suitable wall region or the base of the vial. It is also contemplated that, in certain embodiments, the label 10 can be configured to overlay the container opening if desired or required.

In the embodiment depicted in the various drawing figures, the label 10 and its various component elements are depicted as rectilinear planar members. It is within the purview of this disclosure that the one of more of the elements can have other suitable configuration(s) based upon considerations that include but are not limited to the desired location on the container in question.

The base label member 12 can be of any size and shape suitable to be affixed to the associated container. In certain embodiments, the base label member 12 can have a square or rectilinear configuration however other configurations are considered to be with in the purview of this disclosure. The base label member 12 can have an area A_{B} between 0.2 square inches and 30 square inches in certain embodiments. The base member 12 can have a suitable thickness sufficient to provide structural support the associated label 10.

In certain embodiments, the base label member can be rectilinear and have dimensions up to 5 inches by up to 8 inches, with dimensions between 0.5 and 2 inches by between 0.5 and 4 inches in certain applications. In certain applications, the base label 12 can have dimensions between 0.5 and 1 inch×between 0.5 and 2 inches.

At least one of the first base label face 14 or the second base label face 16 can be configured with indicia 50 that can include artwork, writing or the like. The indicia 50 can be imparted on the first base label face 14 and/or the second base label face 16 by any suitable method such as printing embossing and the like. In certain embodiments, it is contemplated that the indicia 50 will be imparted on the base label face 14, 16 that will be outwardly oriented when the label 10 is in position on the associated substrate such as the desired container. In the various drawing figures base label face 14 is depicted being outwardly oriented in various drawing figures.

In the embodiments depicted in the various drawing figures, the base label member 12 has a rectilinear configuration with a base member length (L_{B}) and a base label member width (W_{B}). In certain embodiments, the base member length (L_{B}) can have a value between 0.2 and 8 inches while the base label member width (W_{B}) can be between about 0.2 and 6 inches. In certain embodiments, the base label member can have a length (L_{B}) between 0.5 and 4 inches and a width (W_{B}) between 0.5 and 3 inches.

The base label member 12 can also include suitable means for attaching the base label member 12 to a suitable substrate such as substrate S as depicted in FIG. 4. Means for attachment can include, but need not be limited to attachment device(s) 52. Non-limiting examples of such attachment device(s) 52 include regions of adhesive material or the like which are illustrated out of scale for purposes of illustration and are connected to the second base label face 16 in a suitable manner. In certain embodiments, the attachment device(s) 52 are directly connected or affixed to the second base label face 16. The location and amount of adhesive material employed as attachment device(s) 52 will be that sufficient to maintain the associated label 10 in fixed attachment to the substrate container.

The label 10 also includes a fold label member 18 that is located in overlying relationship to the base label member 12. The fold label member 18 can include at least one leaf or page. In many applications, the fold label member 18 can include a plurality of leaves or pages that are connected to one another. The plurality of leaves or pages can be connected to one another by binding as a codex, by folding, by pleating or the like such that, when the fold label member 18 is in the folded state, it includes a first outwardly oriented fold label member face 20 and a second outwardly oriented fold label member face 22 that is opposed to the first outwardly oriented fold label member face 20. The various pages or leaves can include printed material related to dosing instructions, use instructions, adverse indications, etc. as required. In certain embodiments, it is contemplated that at least one of the first outwardly oriented fold label member face 20 or the second outwardly oriented fold label member face 22 can include indicia 52 so located that the indicia 52 can be identified when he associated label 10 is in the use position. The fold label member 18 can be composed of any suitable material. In certain embodiments, the fold label member 18 can be composed of a suitable paper.

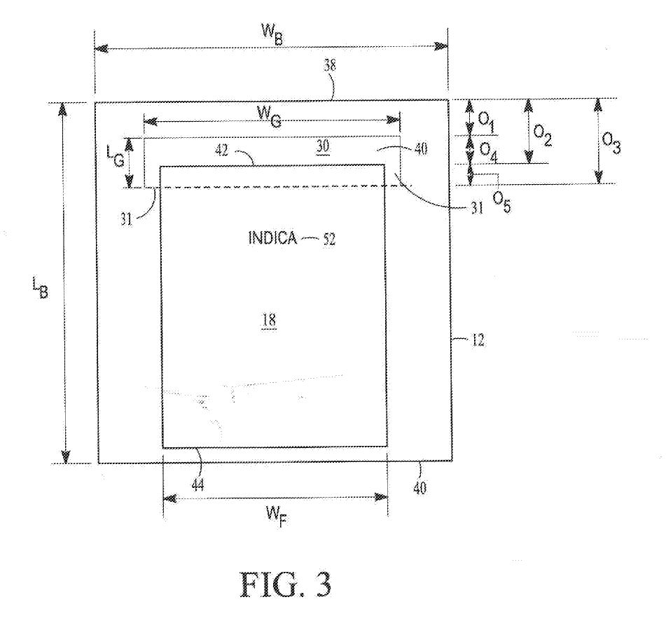

The fold label member 18 can have dimensions in either length, width or both, that are equal to or are less than corresponding dimensions of the associated base label member 12 as illustrates can be seen in the embodiment depicted in FIG. 3. The fold label 18 can have any suitable geometric configuration. In the embodiment depicted in the drawing figures, the fold label member 18 can have a generally planar rectilinear configuration and can have dimensions that are sufficient to be contained within one or more of the boundaries defined by the base label member 12. In certain embodiments, the fold label member 18 will have a dimensional area A_{F} value that is between 70 and 90% of the dimensional area value A_{B} of the base label member 12.

In the various embodiments, the fold label member 18 can be contact with at least a portion of the first base label face 14 of the base label member 12. In certain embodiments, the two respective members are oriented in parallel planar alignment with one another. In the embodiment as illustrated, the fold label member 18 is in direct contact with the base label member 12.

The label 10 also includes a lamination layer 24 that is in overlying relationship with the base label member 12 and the fold label member 18 such that the fold label member 18 is interposed between the base label member 12 and the lamination layer 24. In certain embodiments, the lamination layer 24 is an elongate body that has a first lamination layer face 26 and an opposed second lamination layer face 28. The lamination layer 12 can be composed of any suitable material such as a polymeric film or the like. In certain embodiments, it is contemplated that the polymer film material can be a transparent material that will permit visibility of any layers and/or indicia that underlie the lamination layer, for example indicia 54 present on the first outwardly oriented face 20 of the fold label member 18. This can facilitate user identification of the label 10 and the presence and nature of the fold label member 18.

The lamination layer 24 can include means for affixing the lamination layer 24 to the base label member 12 with the fold label member 18 interposed in between. The affixing means can be a suitable adhesive layer positioned on the second lamination layer face 28 at suitable locations. The adhesive employed in the adhesive layer can be one suitable for attaching the lamination layer 24 to the base layer member 12. The adhesive employed can be one that provides a sufficient prying force to permit disengagement of the lamination layer 24 from the base member layer 12 when access to the fold label member 18 is desired.

As illustrated in FIG. 3, the base label member 12 can be configured as an elongate body that has a base label member leading edge 38 and a base label member trailing edge 40 that is opposed to the base label member leading edge. In certain embodiments, the trailing edge of the base label member 12 will be configured to permit disengagement of the lamination layer 24 from contact with the base label member 12 either completely or to an extent sufficient to access the fold label member 18.

The label 10 also includes a glue hinge 30 that is positioned in overlaying relationship with a region defined on the first base label face 14 of the base label member 12. The glue hinge 30 is in contact with the first base label face 14 at a location and in a manner that facilitates contact with and connection to both the lamination layer 24 and the fold label member 18 when the components of the label 10 are in their assembled state.

In the embodiment as depicted in the various drawing figures, the glue hinge 30 can be a suitably configured member that has a glue hinge area (A_{G}) that is less than the value of base label member area (A_{B}). In certain embodiments, the glue hinge 30 can be an elongated rectilinear member that has a length L_{G} that is less than the length L_{B} of base label member 12. The length L_{G} of glue hinge 30 will be sufficient to permit visibility of indicia 50 when fold label member 18 is not in overlying relationship thereto.

The glue hinge 30 can be positioned in offset relationship relative to a central region defined in the base label member 12. Where desired or required, the glue hinge 30 can be located on the base label member 12 at a position proximate to the base label member leading edge 38 of base label member 12 in spaced relationship there from to define an offset length O₁. In certain embodiments, the offset length O₁ can have a value that is between 5% and 20% of the length L_{B} of the base label member 12. Where desired or required, the glue hinge 30 can have a leading edge and an opposed trailing edge.

In certain embodiments, the glue hinge 30 can have a width W_{G} that is between 60% and 95% of the width W_{B} of the base label member 12. In embodiments in which the glue hinge is an elongate rectilinear member, it is contemplated that the width W_{G} will be sufficient to permit the glue hinge 30 to affix to the base label member 12. In certain embodiments, the length L_{G} of the glue hinge 30 can have a value that is between 10% and 40% greater than the length L_{B} of base label member 12. The glue hinge 30 can have an offset value O₃ as measured from the leading edge 38 of the base label member 12 to the trailing edge of the glue hinge 30 that is between 40 and 80% of the value of O₁.

The glue hinge 30 can be composed of a suitable adhesive material or materials sufficient to affix the fold label member 18 to the base label member 12 in a manner that facilitates access to the multiple pages or leaves present in the fold label member 18. In certain embodiments, the glue hinge 30 can include one or more suitable hot melt adhesive(s). Non-limiting examples of suitable hot melt adhesives include one or more of the following: various ethylene vinyl acetate copolymeric resin compositions, ethylene acetate copolymeric resins, polyolefins, polyamides and the like. The hot melt adhesive may also include one or more of the following additive: tackifying resins, waxes, plasticizers and the like.

The fold label member 18 can be configured as an elongated member with a fold label member attachment edge 42 and a fold label member trailing edge 44 that is opposed to the fold member attachment edge 42. In an embodiment of the label 10 as disclosed herein, the attachment edge 42 and a region proximate thereto are adhesively connected to an outwardly oriented face of the glue hinge 30 such that the fold label member 18 overlays a portion of the outwardly oriented face of the glue hinge 30 and a portion of the adhesive material that makes up the glue hinge 30 remains exposed when the fold label member 18 is in position and is in direct contact with the associated region of second lamination layer face 28.

In certain embodiments, the fold label member attachment edge 42 is positioned at a region central to the elongate body of the glue hinge 30 and defines an offset value O₂ as measured from the leading edge 38 of the base label member 12 to the attachment edge 42 of the fold label member 18 in which the value of O₂ is less that O₃ and greater than O₁. The generally elongate region of the glue hinge 30 that is exposed when the fold label member 18 is affixed to the glue hinge 30 will have a value O₄. In the embodiment depicted in FIG. 3, the value of O₁ is approximately the same value as O₄. It is contemplated that, in certain embodiments, O₄ can be greater than O₁. It is contemplated that O₄ and O₅ can have values sufficient to oriented and anchor the fold label member 18 in the associated assembly. The ratio of O₄ to O₅ be between 3:1 and 1:3 in various embodiments depending on a variety of factors. These factors include but need not be limited to the size and/or thickness of the fold label member, strength of the adhesive material employed in the glue hinge, etc. In certain embodiments, it is contemplated that the ratio of O₄ to O₅ can be between about 2:1 and 1:2.

In certain embodiments, the width W_{F} of the fold label member 18 can have a value that is equal to or less than the width W_{G} of glue hinge 18. In certain embodiments, the ratio of the width W_{F} of fold layer member 18 to the width W_{G} of glue hinge 18 can be between 0.5:1 and 1:1. In various embodiments, the fold layer member 18 can be centered relative to the glue hinge 18. In embodiments where the width W_{F} of fold layer member 18 is less than the width W_{G} of glue hinge 18, it is contemplated that the resulting assembly of glue hinge 18 and fold label member 18 will include side tab regions 31 defined on the glue hinge 18.

Where desired or required, the glue hinge 18 can be configured with suitable tamper indicators that would indicate that the label has been altered from its as manufactured state. Such alterations can include removal and/or replacement of the fold label member 18, etc. Non-limiting examples of tamper indicators can include stress indicators integrated in the glue hinge that are triggered by movement/removal of the overlying lamination layer 24.

The lamination layer 24 that overlays the base layer member 12 and fold label member 18 can have dimensions equal to the dimensions of the base label member 12 if desired or required. When the lamination layer 24 is in position overlaying the glue hinge 30 and the fold label member 18, one or more outer edges of the lamination layer 24 can extend beyond one or more outer edges defined in the fold label member 12 and the glue hinge 18 when the various members are assembled together as can be seen in FIGS. 6 and 7 to surround the glue hinge 30 and the fold label member 18. Where desired or required, the respective regions of the laminations layer 24 and base label member 12 can be in fixed contact with one another as by adhesive bonding, melt boding or the like. The bond contact between the two respective regions can be on the that is sufficient to maintain the base label member 18 and the lamination layer in contact with each other during manufacture, transfer to the desired container substrate S and shipping and storage of the associated container but can be separated by the end user or consumer to access the fold label member 18.

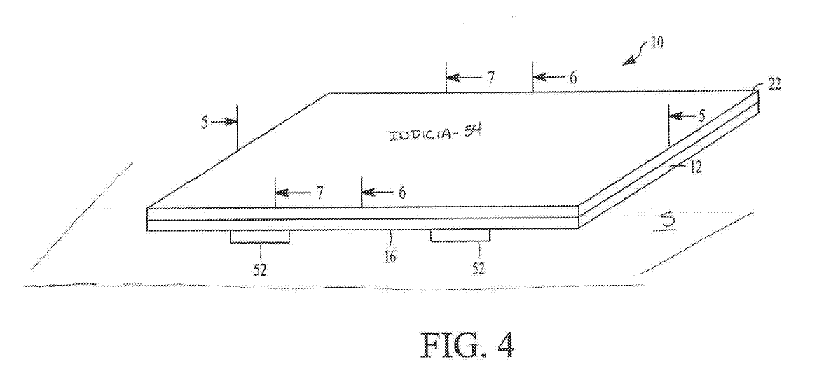

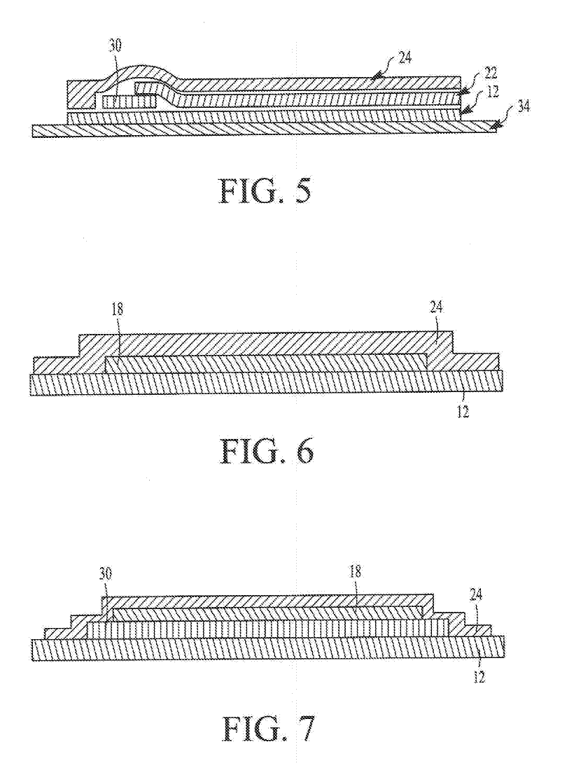

The trailing edges of the respective members of the label 10 can be configures such that the fold label member 18 is encased between the lamination layer 24. One non-limiting example of such encasement is the embodiment depicted in FIGS. 4-7. It is also considered within the purview of this disclosure to position the fold member trailing edge 43 and the lamination layer trailing edge 44 in parallel stacked relationship to one another as is illustrated in FIG. 5. Where desired or required, the base member trailing edge 40 can be in parallel stacked relationship with one or more of the fold member trailing edge 43 and/or the lamination layer trailing edge 44 as illustrated in the embodiments of FIGS. 1 and 5.

The label 10 is configured to be attached to a suitable support surface. As discussed previously in the use position, the label 10 can be affixed to a suitable container device such as that depicted in FIG. 4 as reference numeral S. The label 10 can be affixed in any suitable manner as by adhesive or the like.

It is also within the purview of this disclosure that label 10 include a suitable support surface such a liner layer 34 which may be employed as a transfer or storage aid prior to affixing the label 10 to the container substrate S. The liner layer 34 can have a support face 36 that is in releasable contact with the second base label face 16 of the base label member 12. The liner layer 34 can be an elongate body configured to carry one or more labels 10 thereon and to facilitate transfer of individual labels 10 to respective containers S. In the embodiment illustrated in FIG. 1, one assembly comprising the base member 12, fold label member 18, lamination layer 24 and glue hinge 30 is present on the liner layer 34. It is contemplated the two or more assemblies can be present on the associated liner layer 34 and can be mounted thereto in a manner that facilitates their removal from the liner layer 34 to associated container substrates S. It is also considered to be with in the purview of this disclosure that two or more assemblies can be present on the liner layer in different stages of assembly. Thus, one or more of the assemblies can include less than the total number of elements previously enumerated. The liner 34 can be made of a suitable material such as paper, polymeric film and the like and can present as a single linear member or as a continuous loop as desired or required.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A label comprising:
a base label member having a first base label face and a second base label face opposed to the first base label face;
a fold label member in overlying relationship to the base label member, the fold member having a first outwardly oriented fold label member face and a second outwardly oriented fold label member face opposed to the first outwardly oriented fold label member face when the fold label member is in a folded state;
a lamination layer in overlying relationship with the base label member and the fold label member, the lamination layer having first lamination layer face and a second lamination layer face, wherein the first lamination layer face is opposed to the first lamination layer face; and
a glue hinge, the glue hinge in overlaying relationship to a region defined on the first base label face, the glue hinge in contact with the fold label member and the lamination layer.

2. The label of claim 1 further comprising a liner layer, the liner layer having a support face, the support face in contact with the base label member.

3. The label of claim 1 wherein the first base label member face of the base label member has a base and wherein the having a base label member length (L_{B}) and a base label member width (W_{B}), and wherein the glue hinge has a glue hinge area (A_{G}) having a glue hinge base label (L_{G}) and a glue hinge width (W_{G}), wherein the glue hinge area is less than the base label area and wherein the glue hinge is positioned in offset relationship relative to a central region defined in the base label member.

4. The label of claim 3 wherein the base label member has a base label member leading edge and a base label member trailing edge opposed to the base label member leading edge, and where the glue hinge is positioned on the proximate to the base label member leading edge of the base label member in spaced relationship thereto.

5. The label of claim 4 wherein the glue hinge has an elongate body positioned in spaced parallel relationship to the base label member attachment edge of the base label member and wherein the fold label member has a fold label member attachment edge and a fold label member trailing edge, the fold label trailing edge opposed to the fold label member attachment edge, the fold label attachment edge positioned at a region central to the elongate body of the glue hinge.

6. The label of claim 5 wherein lamination layer includes a lamination layer leading edge that is located proximate to the glue hinge and a lamination layer trailing edge opposed to the lamination layer leading edge, the lamination layer trailing edge extending beyond the base label open edge fold label member open edge.

7. The label of claim 6 wherein the lamination layer leading edge is offset from the leading edge of the base label member.

8. The label of claim 4 wherein the fold label trailing edge is disposed even with the base layer member trailing edge.

9. The label of claim 1 wherein the fold label member includes a plurality of leaves, the plurality of leaves oriented in one at least one of: a codex, a pleat, a combination of codex and pleat.

10. A label comprising:
a base label member having a first base label face and a second base label face opposed to the first face, the base label member having at least one attachment mechanism located on the second base label face;
a fold label member in overlying relationship to the base label member, the fold member having a first outwardly oriented fold label member face and a second outwardly oriented fold label member face opposed to the first outwardly oriented fold label member face when the fold label member is in a folded state, the fold label member having a plurality of stacked leaves, the stacked leaves connected to one another as a codex, and elongated pleated member or as a combination of codex and pleated member, wherein a portion of the second outwardly oriented fold label member face directly overlies the first base label face of the base label member;
a lamination layer in overlying relationship with the base label member and the fold label member, the lamination layer having first lamination layer face and a second lamination layer face wherein the second lamination layer face is opposed to the first lamination layer face, and wherein at least a portion of the second lamination layer face is in overlying contact with the first outwardly oriented fold layer member face of the fold layer member; and
a glue hinge interposed between the base label member, the fold label member and the lamination layer, the glue hinge in direct contact with a defined region on the first base label member, a defined region on the fold label member and a defined region on the second. lamination layer face.

11. The label of claim 10 further comprising:
at least one support substrate member, the at least one substrate member being one of a liner layer or a container device;
at least one attachment mechanism connected to the second base label member face, the at least one attachment mechanism interposed between the support substrate member and the fold label member.

12. The label of claim 11 wherein the fold label member includes a plurality of leaves, the plurality of leaves oriented in one at least one of: a codex, a pleat, a combination of codex and pleat.

13. The label of claim 12 wherein the first base label member face of the base label member has a base label member area (A_{B}) and wherein the having a base label member length (L_{B}) and a base label member width (W_{B}), and wherein the glue hinge has a glue hinge area (A_{G}) having a glue hinge base label (L_{G}) and a glue hinge width (W_{G}), wherein the glue hinge area is less than the base label area and wherein the glue hinge is positioned in offset relationship relative to a central region defined in the base label member.

14. The label of claim 13 wherein the base label member has a base label member leading edge and a base label member trailing edge opposed to the base label member leading edge, and where the glue hinge is positioned on the proximate to the base label member leading edge of the base label member in spaced relationship thereto, and wherein the fold label trailing edge is disposed even with the base layer member trailing edge.

15. The label of claim 14 wherein the glue hinge has an elongate body positioned in spaced parallel relationship to the base label member attachment edge of the base label member and wherein the fold label member has a fold label member attachment edge and a fold label member trailing edge, the fold label trailing edge opposed to the fold label member attachment edge, the fold label attachment edge positioned at a region central to the elongate body of the glue hinge.

16. The label of claim 15 wherein lamination layer includes a lamination layer leading edge that is located proximate to the glue hinge and a lamination layer trailing edge opposed to the lamination layer leading edge, the lamination layer trailing edge extending beyond the base label open edge fold label member open edge.

17. The label of claim 16 wherein the lamination layer leading edge is offset from the leading edge of the base label member.

18. A label comprising:
a base label member having a first base label face and a second base label face opposed to the first face, the base label member having at least one attachment mechanism located on the second base label face;
a fold label member in overlying relationship to the base label member, the fold member having a first outwardly oriented fold label member face and a second outwardly oriented fold label member face opposed to the first outwardly oriented fold label member face when the fold label member is in a folded state, the fold label member having a plurality of stacked leaves, the stacked leaves connected to one another as a codex, and elongated pleated member or as a combination of codex and pleated member, wherein a portion of the second outwardly oriented fold label member face directly overlies the first base label face of the base label member;
a lamination layer in overlying relationship with the base label member and the fold label member, the lamination layer having first lamination layer face and a second lamination layer face wherein the second lamination layer face is opposed to the first lamination layer face, and wherein at least a portion of the second lamination layer face is in overlying contact with the first outwardly oriented fold layer member face of the fold layer member; and
a glue hinge interposed between the base label member, the fold label member and the lamination layer, the glue hinge in direct contact with a defined region on the first base label member, a defined region on the fold label member and a defined region on the second. lamination layer face,
wherein the first base label member face of the base label member has a base and wherein the having a base label member length (L_{B}) and a base label member width (W_{B}), and wherein the glue hinge has a glue hinge area (A_{G}) having a glue hinge base label (L_{G}) and a glue hinge width (W_{G}), wherein the glue hinge area is less than the base label area and wherein the glue hinge is positioned in offset relationship relative to a central region defined in the base label member.

19. The label of claim 18 wherein the base label member has a base label member leading edge and a base label member trailing edge opposed to the base label member leading edge, and where the glue hinge is positioned on the proximate to the base label member leading edge of the base label member in spaced relationship thereto and wherein the glue hinge has an elongate body positioned in spaced parallel relationship to the base label member attachment edge of the base label member and wherein the fold label member has a fold label member attachment edge and a fold label member trailing edge, the fold label trailing edge opposed to the fold label member attachment edge, the fold label attachment edge positioned at a region central to the elongate body of the glue hinge.

20. A label assembly comprising:
a liner layer, the liner layer having an elongate body having a support face;
a plurality of labels releasably mounted on the liner layer, each label comprising:
a base label member having a first base label face and a second base label face opposed to the first base label face;
a fold label member in overlying relationship to the base label member, the fold member having a first outwardly oriented fold label member face and a second outwardly oriented fold label member face opposed to the first outwardly oriented fold label member face when the fold label member is in a folded state;
a lamination layer in overlying relationship with the base label member and the fold label member, the lamination layer having first lamination layer face and a second lamination layer face, wherein the first lamination layer face is opposed to the first lamination layer face; and
a glue hinge, the glue hinge in overlaying relationship to a region defined on the first base label face, the glue hinge in contact with the fold label member and the lamination layer.
